(19) United States
(12) Patent Application Publication
(10) Pub. No.: US 2015/0230394 A1
(43) Pub. Date: Aug. 20, 2015

(54) FEED MECHANISM TO ALLOW POSITIVE FEEDING OF ENERGY CANES INTO A CHOPPER MECHANISM

(71) Applicant: BP CORPORATION NORTH AMERICA INC., Houston, TX (US)

(72) Inventor: John Finley Larsen, Katy, TX (US)

(73) Assignee: BP Corporation North America Inc., Houston, TX (US)

(21) Appl. No.: 14/419,213

(22) PCT Filed: Aug. 1, 2013
(86) PCT No.: PCT/US2013/053180

§ 371 Date: Feb. 2, 2015

Related U.S. Application Data
(60) Provisional application No. 61/784,855, filed on Mar. 14, 2013.
(60) Provisional application No. 61/678,997, filed on Aug. 2, 2012.

(51) Int. Cl. A01C 1/00; A01C 14/00; A01C 7/00; A01C 5/06

(52) U.S. Cl. CPC A01C 1/00; A01C 5/062; A01C 14/00; A01C 7/00

(57) ABSTRACT

A feed mechanism (22) for feeding plants (24) into a chopper, including a loading mechanism (26) that uses gravity to feed plants into a chopper feed mechanism, and a chopper feed mechanism including a drive wheel (36) and a belt (38) for feeding plants to a chopper (48). A mechanical planter may include the feed mechanism. The feed mechanism may also be used in a method of planting energy cane.

### BACKGROUND

1. Technical Field

The invention relates to a feed mechanism for feeding plants into a chopper. Aspects of the invention relate to a mechanical planter that includes the feed mechanism, as well as methods of planting energy cane using the feed mechanism.

2. Discussion of Related Art

Energy cane is not generally started from seed when commercially grown. Instead, energy cane is clonally propagated by means of “seed-cane” which is a section of a mature cane stalk with buds or eyes located at the nodes. Billets, or cut sections of mature energy cane stalk, are planted horizontally in plowed furrows and then covered with soil. For a new energy cane plant to grow, each billet that is planted must contain at least one bud, eye, or node. In practice, however, not all nodes generate new plants. Thus, it is desirable to have at least three nodes, and often four or five nodes, on each billet that is planted.

Billet cutting and planting are laborious tasks that are often conducted by hand. Mechanical planters that cut manually-fed energy cane stalks, open the ground, lay down the billet, and reclose the ground have been developed, but these systems all have major disadvantages. For example, current mechanical planters need to be hand-fed and the operator needs to apply positive pressure by pushing the stalk into the cutter until a pull is felt from the drive wheels; the drive wheels are typically two hard rubber wheels that spin in order to “grab” the stalk. This requirement to hand-feed stalks into the cutter represents a safety issue for the operator.

Also, if multiple energy cane stalks are being fed and the stalks differ in circumference, the largest stalk is quickly pulled into the machine while thinner stalks do not feed well. These feeding inconsistencies result in variably sized billets and additional effort and safety risks by the operator.

An additional drawback to current mechanical planters is that the plowing mechanisms used to open the ground for planting disturb much more soil than is necessary. This results in the release of a large amount of carbon into the atmosphere, and also damages the planting beds.

There is thus a need and desire for a mechanical planter for planting energy cane that automatically feeds stalks into the cutter. There is a further need and desire for a mechanical planter for planting energy cane that results in a more consistent size distribution among the billets.

### SUMMARY

The invention is directed to a feed mechanism for feeding plants into a chopper, as well as a mechanical planter that includes the feed mechanism, and methods of planting energy cane using the feed mechanism. The feed mechanism automatically feeds stalks into the chopper, thus resulting in a safer, faster, and less strenuous planting system, as well as a more consistent size distribution among the billets.

According to some embodiments, a feed mechanism for feeding plants into a chopper may include a loading mechanism that uses gravity to feed plants into a chopper feed mechanism, and a chopper feed mechanism that feeds plants to a chopper. The loading mechanism may include a rack onto which the plants are stacked, and a hopper into which the plants are fed. The hopper may have an upper surface that is positioned at an angle of at least about 15° from vertical.

The chopper feed mechanism may include a drive wheel and a belt made of soft ply rubber, such as natural rubber and/or gum rubber. The belt may be ribbed. In certain embodiments, the belt may be hinged at a distal end to provide variable spacing between the drive wheel and a proximal end of the belt. Additionally, the chopper feed mechanism may include an air shock or other type of shock assembly positioned near the proximal end of the belt that further enables variable spacing between the drive wheel and the proximal end of the belt. The drive wheel and the belt may be run at about the same speed.

The chopper feed mechanism may feed one or more plant stalks at a time to the chopper. In certain embodiments, the chopper feed mechanism may simultaneously feed multiple plant stalks of differing diameters.

According to some embodiments, a mechanical planter may include a loading mechanism that automatically loads plants into a chopper feed mechanism, a chopper feed mechanism for feeding plants to a chopper mechanism, a chopper mechanism that cuts the plants into billets, and a plow that digs furrows in the ground.

As described above with respect to the feed mechanism, the chopper feed mechanism in the mechanical planter may also include a drive wheel and a belt made of soft ply rubber, such as natural rubber and/or gum rubber. The belt may be ribbed. In certain embodiments, the belt may be hinged at a distal end to provide variable spacing between the drive wheel and a proximal end of the belt. Additionally, the chopper feed mechanism may include an air shock or other type of shock assembly positioned near the proximal end of the belt that further enables variable spacing between the drive wheel and the proximal end of the belt. The drive wheel and the belt may be run at about the same speed. The belt may be located in a various positions, for example, but not limited to, on top, on the side, or various angles in order to allow for positive feeding into the chopper mechanism. The chopper feed mechanism may feed one or more plant stalks at a time to the chopper. In certain embodiments, the chopper feed mechanism may simultaneously feed multiple plant stalks of differing diameters.

The chopper mechanism may include an active circular saw blade.

The plow may include a double disk opener.

The mechanical planter may also include a planting device that lays the billets in the plowed furrows. In certain embodiments, the mechanical planter may also include a device that covers the billets with dirt in the plowed furrows.

According to some embodiments, a method of planting energy cane may include loading one or more stalks of energy cane into a loading mechanism and releasing the stalk or stalks, thus allowing gravity to feed the stalk or stalks into a chopper feed mechanism. A chopper mechanism is then used to cut the stalk or stalks into a plurality of billets. After plowing furrows, the billets may then be planted in the plowed furrows.

As described above with respect to the feed mechanism and the mechanical planter, the chopper feed mechanism used in the methods herein may also include a drive wheel and a belt made of soft ply rubber, such as natural rubber and/or gum rubber. In certain embodiments, the belt may be hinged at a distal end to provide variable spacing between the drive wheel and a proximal end of the belt. Additionally, the chopper feed mechanism may include an air shock or other type of shock assembly positioned near the proximal end of the belt that further enables variable spacing between the drive wheel and the proximal end of the belt.

When loading stalks of energy cane into the loading mechanism, a subsequent stalk may be loaded into the loading mechanism when the previous stalk or stalks are at least half-way into the loading mechanism. Also, two or more stalks may be loaded into the loading mechanism at the same time, even when the stalks differ in barrel size.

The chopper mechanism used to cut the stalk or stalks may include an active circular saw blade.

In certain embodiments, a double disk opener may be used to plow the furrows.

The machines and methods described herein may be used with a variety of plants, including lignocellulosic materials such as energy cane. More particularly, the plants may include sugarcane, bamboo, miscanthus, napier grass, sorghum, arundo, switchgrass, and hybrids thereof and/or combinations thereof.

The machines and methods described herein may be used with a variety of agricultural practices for making various products. More particularly, the machines and methods described herein may be used herein for the production of biofuels.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 is a diagram illustrating a mechanical planter according to certain embodiments of this invention.

FIG. 2 is an enlarged view of a chopper feed mechanism within the mechanical planter of FIG. 1, according to certain embodiments of this invention.

### DETAILED DESCRIPTION

The invention is directed to a feed mechanism for feeding plants into a chopper, as well as a mechanical planter that includes the feed mechanism, and methods of planting energy cane using the feed mechanism.

The devices and methods described herein may be used with a variety of plants, including but not limited to crops that yield lignocellulosic biomass.

Lignocellulosic preferably broadly refers to materials containing cellulose, hemicellulose, lignin, juice, and/or the like, such as may be derived from plant material and/or the like. Lignocellulosic material may include any suitable material, such as energy cane, energy cane bagasse, sugarcane, sugarcane bagasse, bamboo, rice, rice straw, corn, corn stover, maize, maize stover, wheat, wheat straw, sorghum, sorghum stover, sweet sorghum, sweet sorghum stover, arundo, cotton remnant, sugar beet, sugar beet pulp, soybean, rapeseed, jatropha, switchgrass, miscanthus, napier grass, other grasses, and hybrids of any of these materials.

Lignin preferably broadly refers to a biopolymer that may be part of secondary cell walls in plants, such as a complex highly cross-linked aromatic polymer that may covalently link to hemicellulose.

Hemicellulose preferably broadly refers to a branched sugar polymer composed mostly of pentoses, such as with a generally random amorphous structure and typically may include up to hundreds of thousands of pentose units.

Cellulose preferably broadly refers to an organic compound with the formula (C₆H₁₀O₅), where z includes any suitable integer. Cellulose may include a polysaccharide with a linear chain of several hundred to over ten thousand hexose units and a high degree of crystalline structure, for example.

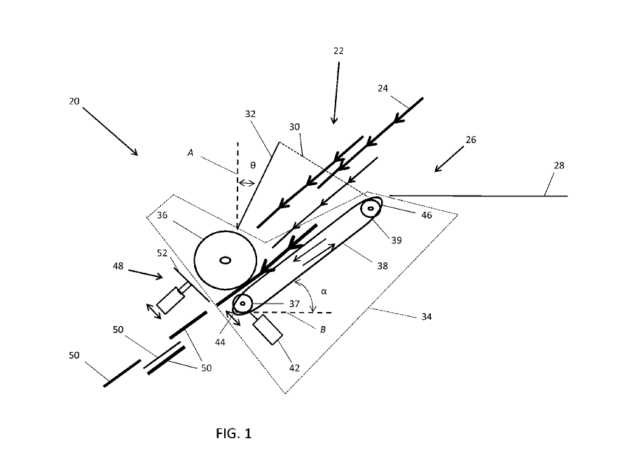

A mechanical planter 20 including a feed mechanism 22 is illustrated in FIG. 1. The feed mechanism 22 allows positive feeding, or automatic feeding, of stalks 24 into a chopper mechanism 48. The feed mechanism 22 includes a loading mechanism 26 and a chopper feed mechanism 34. The loading mechanism 26 uses gravity to feed plants into the chopper feed mechanism 34. More particularly, the loading mechanism 26 includes a rack 28 onto which stalks 24 of the plants can be stacked, and a hopper 30 into which the stalks 24 are fed.

Rather than being positioned in an upright V-shaped position, the hopper 30 is tilted such that a first or upper surface 32 of the hopper 30 is positioned at an angle θ of at least about 15°, or at least about 30°, or between about 30° and about 60° from a vertical axis (A), as shown in FIG. 1. The first or upper surface 32 of the hopper 30 may be fixed in place, with the tilted angle of the first or upper surface 32 configured to force the stalks 24 into the chopper feed mechanism 34 via gravity.

The chopper feed mechanism 34 feeds stalks 24 of plants to a chopper mechanism 48. The chopper feed mechanism 34 includes a drive wheel 36 and a belt 38, which, in an embodiment, may be formed of a soft ply rubber. The drive wheel 36 may be coupled to a shaft that is coupled to a motor (not shown) such that the motor drives the drive wheel 36.

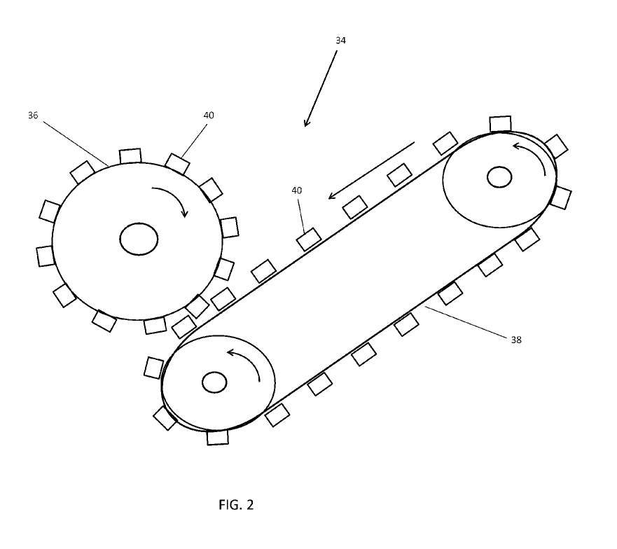

Belt 38 is preferably made of a flexible material and is movably disposed over a first drum 37 and a second drum 39. The belt 38 serves as the floor of the chopper feed mechanism 34. Belt 38 may also be disposed or tilted at an angle α from a horizontal axis (B), as shown in FIG. 1. Angle α may be the same or different from angle θ. In certain embodiments, angle α may be at least about 15°, or at least about 30°, or between about 30° and about 60° from the horizontal axis (B). The soft ply rubber may include, for example, without limitation, natural rubber, synthetic rubber and/or gum rubber. For example, the soft ply rubber may be Natural Rubber belting (durometer 40-60) from F.N. Sheppard & Co. of Erlanger, Kentucky. In other embodiments, the belt 38 may be made of other suitable materials. The drive wheel 36 may be formed of a hard rubber material or a soft ply rubber material, or any other suitable material for driving the stalks 24 toward the chopper mechanism 48. Unlike chopper feed mechanisms that include two hard rubber wheels, the flexibility provided by the soft ply rubber of the belt 38 and/or the drive wheel 36 ensures that the nodes on each stalk 24 are not damaged. Additionally, as shown in greater detail in FIG. 2, the belt 38 and/or the drive wheel 36 may be ribbed with a plurality of raised areas 40 along the surface to assist in feeding the stalks 24 to the chopper mechanism 48.

The flexibility of the combined drive wheel 36 and belt 38 also allows for positive feeding of single stalks 24 as well as multiple stalks 24, and even multiple stalks 24 of different sizes including different diameters. To more easily accommodate stalks 24 of various barrel sizes or diameters, the chopper feed mechanism 34 may include a shock assembly 42, such as, without limitation, an air shock, a pneumatic assembly, or a hydraulic assembly, positioned near a proximal end 44 of the belt 38 that allows for a variable distance between the drive wheel 36 and the belt 38. Additionally or alternatively, the belt 38 may be hinged at a distal end 46 to further accommodate stalks 24 of various sizes. As a result of the ability of the chopper feed mechanism 36 to handle stalks 24 of different sizes equally well, the feed mechanism 22 achieves a more consistent size distribution among the billets 50 compared to hand feeding stalks to a chopper, thus achieving the ability to control apical dominance.

The mechanical planter 20 may be attached to the rear of a tractor or other towing vehicle. Furthermore, the mechanical planter 20 may be connected to a power take-off shaft of a tractor or other power source in order to power the mechanical planter 20. The drive wheel 36 and the belt 38 may be run at about the same speed as one another, and at about the same speed as the tractor or other vehicle towing the mechanical planter 20. More particularly, linear speed is related to the ground speed at which the mechanical planter 20 is moving, which is the target feed rate of the feed mechanism 22. The feed rate may be equal to the ground speed ±2%, or the ground speed ±1%. The example below shows how the feed rate may be calculated.

The mechanical planter 20 may further include a chopper mechanism 48 that cuts the stalks 24 into billets 50. The billets 50 may be between about 14 and about 20 inches long.

In certain embodiments, the billets 50 may be about 18 inches long. In certain embodiments, each billet has at least three nodes. In certain embodiments, each billet has at least four nodes. In certain embodiments, each billet has at least five nodes. In certain embodiments, each billet has at least six nodes. The chopper mechanism 48 may include a blade 52, such as, without limitation, a circular saw blade. Circular saw blade 52 may be powered or rotated via a motor (not shown). Unlike billets cut with a pinch cutter, the active circular saw blade 52 ensures that the billet ends are not damaged or frayed.

Rather than a large plow, the mechanical planter 20 may include a double disk opener (not shown) to open furrows in the ground into which the billets 50 may be placed. The double disk opener ensures that a minimum amount of soil is disturbed, thereby minimizing the carbon footprint of the operation and preserving the planting bed. One example of a commercially-available double disk opener is Model 4612 from K-Hart Industries of Elrose, Saskatchewan, Canada. Any suitable double disk opener may be used.

The mechanical planter 20 may also include a planting device that lays the billets in the plowed furrows, as well as a device that covers the billets with dirt in the plowed furrows. Examples of these devices include the PCP-2 Planter from Santal of Brazil.

Since the feed mechanism 22 automatically, or at least semi-automatically, feeds stalks 24 into the chopper mechanism 48, using the feed mechanism 22 may be much safer, faster, and less strenuous than hand-feeding stalks 24 to a chopper. According to some embodiments, a method of using the feed mechanism 22 to plant energy cane includes loading at least one stalk 24 of energy cane into the loading mechanism 26 and releasing the stalk or stalks 24, thus allowing gravity to feed the stalk or stalks 24 into the chopper feed mechanism 34. The chopper feed mechanism 34 feeds the plants to the chopper mechanism 48. The method further includes using the chopper mechanism 48 to cut the stalk or stalks 24 into a plurality of billets 50. The method may also include plowing furrows, and planting the billets 50 in the plowed furrows.

Stalks 24 are preferably fed into the feed mechanism 22 spaced apart, rather than feeding all of the stalks 24 into the feed mechanism 22 at once. Preferably, the stalks 24 are fed into the feed mechanism 22 at a fairly constant rate. In certain embodiments, proper placement of the billets 50 in the furrows may be achieved by loading a subsequent stalk or stalks 24 into the loading mechanism 26 when a previous stalk or stalks 24 are least half-way into the loading mechanism 26. For example, two stalks 24 may be fed simultaneously into the feed mechanism 22, and when the stalks 24 are half-way into the chopper feed mechanism 28, another stalk 24 may be fed into the feed mechanism 22. As another example, one stalk 24 may be fed into the feed mechanism 22, and when the stalk 24 is halfway into the chopper feed mechanism 34, two more stalks 24 may be fed into the feed mechanism 22. As mentioned above, even the stalks 24 that are fed simultaneously may differ in diameter or barrel size. Prior to feeding the stalks 24 into the feed mechanism 22, a group of stalks 24, such as up to about 30 stalks, or up to about 10 stalks, or between about 1 and 3 stalks, may be laid on the rack 28 until space is available in the chopper feed mechanism 34. Thus, compared to other mechanical planters, the feed mechanism 22 allows additional time to obtain the next group of stalks 24 to feed into the feed mechanism 22.

### EXAMPLE

This example shows how to determine the speed at which the belt of the chopper feed mechanism should be driven. The mechanical planter travels at 1.5 miles per hour. The diameter of the drive wheel on the chopper feed mechanism is 12.12 inches.
Circumference=π Diameter=3.14(12.12)=38.056 inches=3.17 feet
Drive wheel=132 feet/min/3.17 feet=41.64 RPM

Thus, in order to match the planting speed, the drive wheel should rotate at a rate of 41.64 rotations per minute, and the belt should be driven at 132 feet/minute.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

1. A feed mechanism for feeding plants into a chopper, comprising:
a loading mechanism that uses gravity to feed plants into a chopper feed mechanism; and
a chopper feed mechanism including a drive wheel and a belt for feeding plants to a chopper.

2. The feed mechanism of claim 1, wherein the loading mechanism comprises a rack onto which the plants are stacked, and a hopper into which the plants are fed.

3. The feed mechanism of claim 2, wherein the hopper comprises a first surface that is disposed at an angle of at least about 15° from vertical.

4. The feed mechanism of claim 1, wherein the chopper feed mechanism is disposed at an angle.

5. The feed mechanism of claim 1, wherein the chopper feed mechanism further comprises a shock assembly that allows for a variable distance between the drive wheel and the belt.

6. The feed mechanism of claim 1, wherein the belt is hinged at one end.

7. The feed mechanism of claim 1, wherein the drive wheel and the belt are run at about the same speed.

8. The feed mechanism of claim 1, wherein the belt comprises natural rubber and/or gum rubber.

9. The feed mechanism of claim 1, wherein the belt is ribbed.

10. The feed mechanism of claim 1, wherein the drive wheel comprises natural rubber and/or gum rubber.

11. The feed mechanism of claim 1, wherein the drive wheel is ribbed.

12. The feed mechanism of claim 1, wherein the chopper feed mechanism feeds one or more plant stalks at a time.

13. The feed mechanism of claim 1, wherein the chopper feed mechanism simultaneously feeds multiple plant stalks of differing size.

14. The feed mechanism of claim 1, wherein the plants comprise at least one of the group consisting of energycane, sugarcane, bamboo, miscanthus, napier grass, sorghum, arundo, switchgrass, and hybrids thereof.

15. A mechanical planter, comprising:
a loading mechanism that automatically loads plants into a chopper feed mechanism;
a chopper feed mechanism including a drive wheel and a belt for feeding plants to a chopper mechanism;
a chopper mechanism that cuts the plants into billets; and
a plow that digs furrows in the ground.

16. The mechanical planter of claim 15, wherein the chopper feed mechanism further comprises a shock assembly that allows for a variable distance between the drive wheel and the belt.

17. The mechanical planter of claim 15, wherein the belt is hinged at one end.

18. The mechanical planter of claim 15, wherein the chopper feed mechanism feeds one or more plant stalks at a time.

19. The mechanical planter of claim 15, wherein the chopper feed mechanism simultaneously feeds multiple plant stalks of differing size.

20. The mechanical planter of claim 15, wherein the drive wheel and the belt are run at about the same speed.

21. The mechanical planter of claim 15, wherein the belt comprises natural rubber and/or gum rubber.

22. The mechanical planter of claim 15, wherein the belt is ribbed.

23. The mechanical planter of claim 15, wherein the chopper mechanism comprises a circular saw blade.

24. The mechanical planter of claim 15, wherein the plow comprises a double disk opener.

25. The mechanical planter of claim 15, further comprising a planting device that lays the billets in the plowed furrows.

26. The mechanical planter of claim 25, further comprising a device that covers the billets with dirt in the plowed furrows.

27. The mechanical planter of claim 15, wherein the plants comprise at least one of the group consisting of energycane, sugarcane, bamboo, miscanthus, napier grass, sorghum, arundo, switchgrass, and hybrids thereof

28. A method of planting energy cane, comprising:
loading at least one stalk of energy cane into a loading mechanism and releasing the at least one stalk, thus allowing gravity to feed the at least one stalk into a chopper feed mechanism including a drive wheel and a belt for feeding plants to a chopper mechanism;
using the chopper mechanism to cut the at least one stalk into a plurality of billets;
plowing furrows; and
planting the billets in the plowed furrows.

29. The method of claim 28, comprising loading a subsequent stalk into the loading mechanism when the at least one stalk is at least half-way into the loading mechanism.

30. The method of claim 28, comprising loading at least two stalks into the loading mechanism, wherein the stalks differ in barrel size.

31. The method of claim 28, wherein the chopper feed mechanism further comprises a shock assembly that allows for a variable distance between the drive wheel and the belt.

32. The method of claim 28, wherein the belt is hinged at one end.

33. The method of claim 28, wherein the belt comprises natural rubber and/or gum rubber.

34. The method of claim 28, wherein the chopper mechanism comprises a circular saw blade.

35. The method of claim 28, comprising using a double disk opener to plow the furrows.

36. The method of claim 28, wherein the energy cane comprises at least one of the group consisting of sugarcane, bamboo, miscanthus, napier grass, sorghum, arundo, switchgrass, and hybrids thereof.

37. The method of claim 15, wherein each billet cut by the chopper mechanism has at least three nodes, four nodes, five nodes or six nodes.
